(19) United States
(12) Patent Application Publication
(10) Pub. No.: US 2025/0295181 A1
(43) Pub. Date: Sep. 25, 2025

(54) Multilayer Absorbent and Waterproof Article

(71) Applicant: Lindsey Hosek, Virginia Beach, VA (US)

(72) Inventor: Lindsey Hosek, Virginia Beach, VA (US)

(21) Appl. No.: 18/642,870

(22) Filed: Apr. 23, 2024

Related U.S. Application Data
(60) Provisional application No. 63/567,456, filed on Mar. 20, 2024.

(51) Int. Cl. A41B 13/10; B32B 5/02; B32B 5/26; B32B 27/12

(52) U.S. Cl. CPC A41B 13/10; B32B 5/02; B32B 5/26; B32B 27/12; A41D 2400/00; A41D 2500/00; B32B 2262/065; B32B 2262/14; B32B 2307/7145; B32B 2307/726; B32B 2307/7265; B32B 2437/00; B32B 2479/00

(57) ABSTRACT

The invention pertains to a layered article designed for fluid protection, comprising a configuration that includes at least one outer fabric layer, at least one absorbent inner layer situated beneath the outer fabric layer, and at least one waterproof inner membrane layer positioned beneath the absorbent inner layer. This structure provides effective isolation of fluids, ensuring that moisture absorbed by the inner layer does not permeate through to the outer surface, thereby maintaining the dryness and cleanliness of the external environment adjacent to the article. The layered article is adaptable for various applications including protective garments and bedding, offering enhanced utility across different settings.

### CROSS-REFERENCE TO RELATED APPLICATIONS

This application claims priority to U.S. Provisional Application No. 63/567,456, filed on Mar. 20, 2024. The entirety of the aforementioned provisional application is hereby incorporated by reference for all purposes.

### FIELD OF INVENTION

The present invention relates generally to absorbent and waterproof materials, specifically to a multilayer structure designed for use in protective garments and bedding. The invention is particularly applicable in the fields of healthcare, infant care, and homecare, providing enhanced protection against fluids.

### BACKGROUND

The need for effective protective materials that safeguard clothing and bedding from bodily fluids such as saliva, drool, and reflux, particularly in environments involving infants, patients under medical care, and adults with special needs, is a longstanding and critical concern. Traditional materials used in products like bibs and bedsheets have been limited by their ability to absorb fluids but not prevent the penetration of these fluids beyond the immediate surface.

These traditional designs typically employ single or multiple layers of cotton or polyester, which, while capable of absorbing some amount of fluid, fail to provide a comprehensive barrier against moisture penetration. This limitation results in several drawbacks. Firstly, the absorbed fluid tends to saturate the fabric quickly, necessitating frequent changes of the protective item, whether it be a bib or bedsheet, which is inefficient and impractical, especially in caregiving or clinical settings. Moreover, once the fabric is saturated, the excess fluid can seep through to clothing or the bedding underneath, defeating the purpose of the protective material and potentially leading to discomfort, skin irritation, or hygiene issues for the user.

Furthermore, the lack of an effective moisture barrier in these conventional materials means that they cannot be used reliably in broader applications beyond infant care, such as in medical settings or in the homecare of adults with special needs. The limited functionality of these materials underscores a significant gap in the range of products that can adapt to a variety of protective needs, from managing minor spills in infant care to addressing more significant fluid management in medical and adult care scenarios.

Thus, the development of an improved layer structure for such materials has become crucial. The innovation needed would ideally combine highly absorbent materials with a robust waterproof element that would prevent any fluid from soaking through, thereby enhancing comfort, extending the usability of the material, and maintaining the integrity and hygiene of the underlying surfaces. Such advancements could revolutionize the standard of care and quality of life for many individuals, ranging from everyday infant care to specialized medical and adult care environments, and extending the application of these materials to include bedsheets and other bedding products.

It is within this context that the present invention is provided.

### SUMMARY

The present invention relates to a layered article designed for protective use, comprising at least one outer fabric layer, at least one absorbent inner layer disposed underneath the outer fabric layer, and at least one waterproof inner membrane layer disposed underneath the absorbent inner layer. This configuration allows for effective fluid management by trapping fluids in the absorbent layer while preventing them from passing through to the other side via the waterproof layer, thereby maintaining the dryness and integrity of external surfaces.

In some embodiments, the outer fabric layer is comprised of a variety of materials including polyester, cotton, bamboo fabric, linen, hemp, silk, rayon, modal, lyocell, microfiber, or combinations thereof. This variety allows for customization according to specific durability, comfort, and aesthetic requirements.

In some embodiments, the absorbent inner layer is made from materials such as terrycloth, fleece, or a bamboo-cotton blend. These materials are selected for their superior fluid absorption capabilities, enhancing the effectiveness of the article in fluid management.

In some embodiments, the absorbent inner layer specifically includes terrycloth comprising substantially 80% bamboo and 20% cotton. This composition combines the softness and environmental benefits of bamboo with the durability of cotton, offering an optimal blend for comfort and performance.

In some embodiments, the waterproof inner membrane layer comprises materials such as thermoplastic polyurethane (TPU), polyurethane laminate (PUL), vinyl, silicone, ethylene vinyl acetate (EVA), or combinations thereof. These materials are chosen for their effective barrier properties against moisture penetration, ensuring that the article remains waterproof.

In some embodiments, the article is designed to be double-sided and reversible, featuring a second absorbent inner layer and a second outer fabric layer on the opposing side of the waterproof layer. This design allows the article to be used interchangeably, increasing its versatility and lifespan.

In some embodiments, the article includes one or more fasteners such as snaps, ties, Velcro, or combinations thereof. These fasteners facilitate easy and secure attachment of the article around an object, ensuring that it stays in place during use.

In some embodiments, the layered article is specifically designed as a protective garment for use as bibs and burp cloths, focusing on the needs of infants and caregivers by providing enhanced protection against fluids.

In some embodiments, the article is configured as a protective bedding article, suitable for use as bedding sheets and mattress covers. This application addresses the need for fluid protection in sleeping environments, safeguarding mattresses and linens from moisture.

In some embodiments, the article includes multiple layers in each of the absorbent and waterproof components to bolster fluid absorption and moisture barrier capabilities, thereby enhancing the protective properties of the article.

In some embodiments, the article is dimensioned and configured for use by a diverse range of individuals, including babies, children, adults, and those with special needs, demonstrating its adaptability to different body sizes and requirements.

In some embodiments, the article includes a logo tag that is strategically placed to maintain functionality without obstructing the absorbent and waterproof features, simultaneously promoting brand visibility.

In some embodiments, the article is treated with an antimicrobial agent to inhibit the growth of bacteria and other microorganisms, thus improving the hygienic properties of the article and making it safer for prolonged contact with skin.

### BRIEF DESCRIPTION OF THE DRAWINGS

Various embodiments of the invention are disclosed in the following detailed description and accompanying drawings.

FIG. 1 illustrates an example of an isometric view of an illustrative absorbent and waterproof saliva bib using the layer structure of the present invention.

FIG. 2A illustrates an example of an isometric exploded view showing the separate layers of a double-sided absorbent and waterproof saliva bib.

FIG. 2B illustrates an example of a cross-sectional view of the layers of FIG. 2A in an assembled state as part of an article.

FIG. 2C illustrates an example of a cross-sectional view of an alternative single-sided construction that does not include the second absorbent layer or the second outer fabric layer.

FIG. 3A illustrates an example of a bib configured to rest at the wearer's front with a string tie that loops around the neck.

FIG. 3B illustrates an example of a bib which has a pair of wings configured to wrap around the wearer's neck, with a fastening mechanism at the end of the wings that allows them to detachably couple to one another.

FIG. 3C illustrates an example of a bib with a body having a smaller surface area that wraps around the wearer's neck and only covers a small portion of their front.

FIG. 3D illustrates an example of a bib with a larger surface area with a frilled edge, and which also has wings with fastening mechanisms for detachably coupling to one another.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “about” and “approximately” indicate an acceptable degree of error or variation in measurements, usually within 20%, preferably within 10%, and more preferably within 5% of a given value or range. Numerical values provided in this description are approximate unless stated otherwise.

When referencing the position of one layer or component relative to another, terms such as ‘beneath,’ ‘underneath,’ ‘on top of,’ and ‘above’ should be interpreted broadly. For instance, a layer described as being ‘beneath’ another does not exclude the presence of intermediate layers or structures. Likewise, the terms ‘inner’ and ‘outer’ are used to describe relative positioning within the structure with respect to the nearest surface or boundary.

References to one element being ‘attached,’ ‘coupled,’ or ‘connected’ to another include both direct connections where elements are physically joined together, and indirect connections where additional elements or mechanisms may be present between the connected elements. Example mechanisms for attachment include but are not limited to snaps, ties, Velcro, adhesives, and magnetic couplings.

Unless specifically defined otherwise, references to materials such as ‘polyester,’ ‘cotton,’ ‘TPU’ (thermoplastic polyurethane), and ‘PUL’ (polyurethane laminate) should be interpreted to include any grades, blends, or composites thereof that are suitable for the intended purposes of fluid absorption or barrier functions. For example, the outer fabric layer might be made from a microfiber blend for enhanced durability and moisture wicking, while the waterproof inner layer might incorporate a silicone-treated fabric for improved water resistance.

The invention may include various embodiments where functional equivalents and substitutes are possible. For instance, an absorbent inner layer made from a bamboo-cotton blend may be replaced by layers of hemp fabric or recycled textiles without departing from the core function of fluid absorption. Similarly, modifications in the design such as the addition of more layers or the integration of thermal insulating properties are considered within the scope of the invention as long as they fulfill the intended protective functions.

### DESCRIPTION OF DRAWINGS

The present invention relates to a layered article designed to provide protective barriers against fluids, suitable for a range of applications including, but not limited to, protective garments and bedding. The invention specifically addresses the need for a durable, absorbent, and waterproof solution that maintains the integrity and cleanliness of underlying surfaces when exposed to various fluids.

The article comprises a multilayer configuration that includes at least one outer fabric layer, at least one absorbent inner layer, and at least one waterproof inner membrane layer. This structure is designed to effectively capture and contain fluids within the absorbent layer while preventing them from seeping through to the outermost layer and beyond, due to the presence of the waterproof membrane.

The outer fabric layer serves not only as the first line of defence against external environmental elements but also provides a comfortable touch point for the user. This layer can be fabricated from various materials including, but not limited to, polyester, cotton, bamboo fabric, and blends thereof, which can be chosen based on the specific requirements of softness, durability, and aesthetic preferences.

Beneath the outer fabric layer lies the absorbent inner layer for trapping and holding fluids. Materials used for this layer are selected for their high absorbency and may include terrycloth, fleece, bamboo-cotton blends, and others. The choice of material can influence the overall efficacy and comfort of the article.

The waterproof inner membrane layer is situated underneath the absorbent layer, functioning as a barrier that prevents the passage of fluids to any layers below or adjacent surfaces, especially useful in cases where excessive fluid leaks/spills cause the fabric and absorbent layers above to become saturated. This membrane can be composed of materials such as thermoplastic polyurethane (TPU), polyurethane laminate (PUL), vinyl, silicone, and ethylene vinyl acetate (EVA), each offering robust waterproofing capabilities.

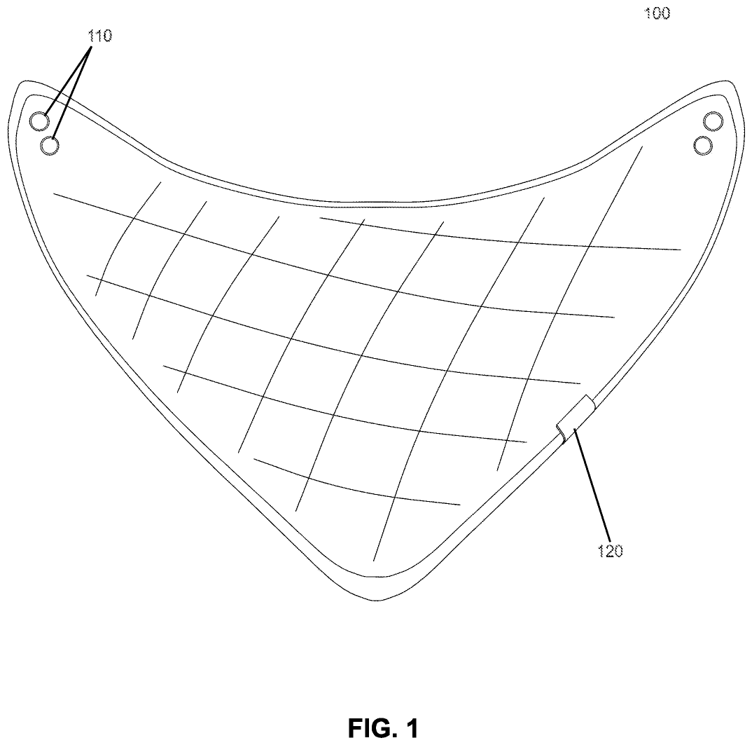

Referring to FIG. 1, an isometric view is presented of an illustrative absorbent and waterproof saliva bib 100 constructed according to the layered structure described in the present invention.

The outer fabric layer of the saliva bib 100 is visible and may come in various colors and designs to suit aesthetic preferences or specific user requirements, such as for babies, children, adults, and even pets like drooling dogs.

The saliva bib 100 includes fasteners 110, such as snaps, ties, or Velcro, strategically positioned to secure the bib around the wearer's neck comfortably and securely. These fasteners 110 are designed to be easy to manipulate, allowing for quick adjustments and removal, which is especially useful in settings involving children or healthcare.

Additionally, a logo tag 120 is incorporated into the design, placed in a manner that ensures it does not interfere with the comfort or functionality of the bib. This tag 120 may serve as a branding element or provide useful product information without detracting from the bib's protective properties.

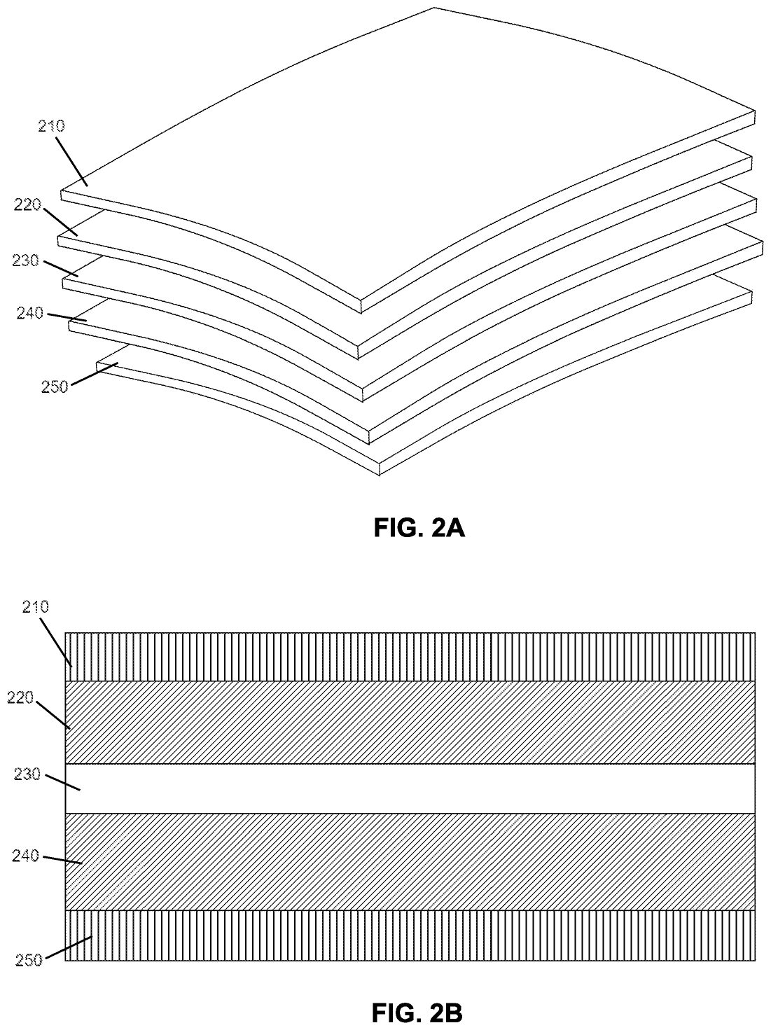

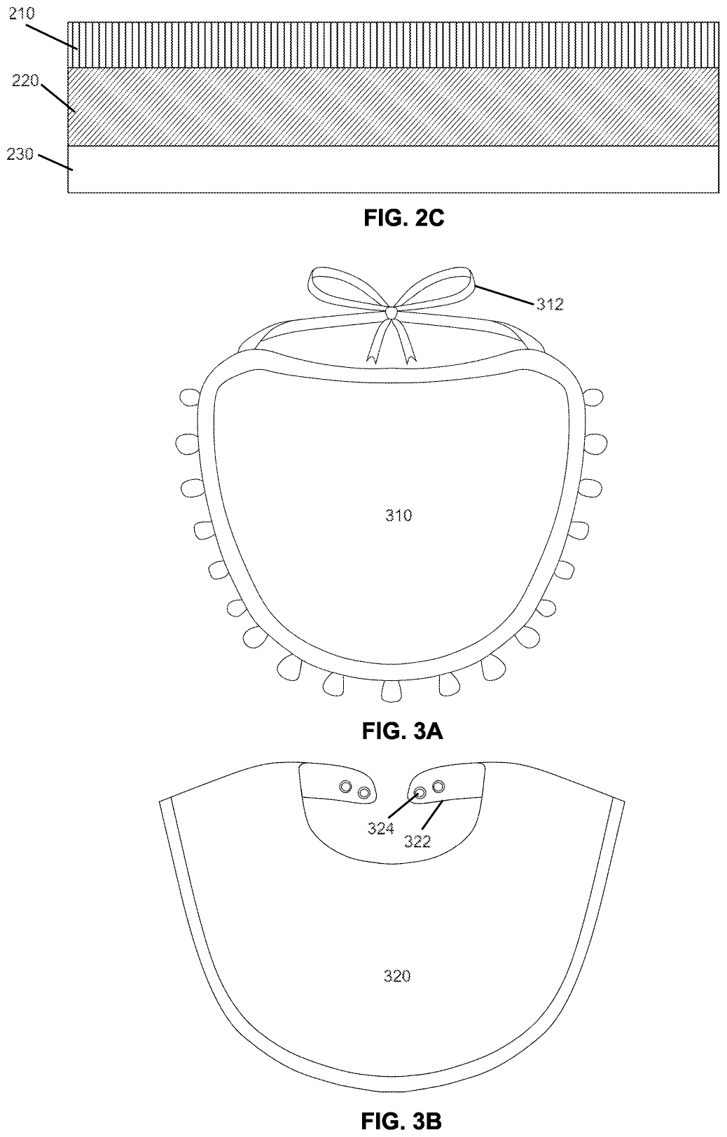

Turning to FIG. 2A, an isometric exploded view is provided that illustrates the detailed layer structure of the double-sided absorbent and waterproof saliva bib.

At the top of the assembly is the outer fabric layer 210, which can be made from polyester or cotton. This layer is designed to offer a soft, comfortable surface that comes into contact with the skin or outer clothing, and is available in various textures and colors to meet different aesthetic and functional needs.

Directly beneath the top outer fabric layer 210 is the first absorbent inner layer 220. This layer is primarily made from terrycloth, ideally comprising about 80% bamboo and 20% cotton, which provides excellent moisture absorption and a soft feel. The use of bamboo not only increases the absorbency but also adds to the environmental sustainability of the product due to bamboo's natural growth characteristics and minimal need for pesticides.

The central layer in this structure is the waterproof inner layer 230, for ensuring that no moisture passes through to the opposite side even if the front side of the article becomes saturated with fluid. This layer is typically constructed from thermoplastic polyurethane (TPU), known for its robust waterproof properties as well as its flexibility and durability. TPU is excellent for maintaining the integrity of the barrier over time and under stress, such as during washing and regular use.

The opposing side of the waterproof inner layer 230 mirrors the construction of the first side, with a second absorbent inner layer 240 and a second outer fabric layer 250 on top of that, mirroring the top layer and made from the same materials. This configuration not only adds to the aesthetic and functional symmetry of the bib but also allows the article to be reversible, thereby extending its usability and versatility.

Turning to FIG. 2B, a cross-sectional view is provided which illustrates the layers of FIG. 2A in their assembled state, forming part of the double-sided absorbent and waterproof saliva bib.

FIG. 2C shows a cross-sectional view of an alternative construction of the saliva bib, depicting a single-sided version that omits the second absorbent layer and the second outer fabric layer. This configuration comprises the top outer fabric layer 210, under which lies the first absorbent inner layer 220. The waterproof inner layer 230 remains centrally located beneath the first absorbent layer, ensuring that no moisture breaches this barrier. The absence of the additional layers on the opposing side makes this version lighter and potentially more suitable for situations where less bulk and simpler construction are advantageous, such as in lightweight apparel or single-use applications where reversibility is not necessary.

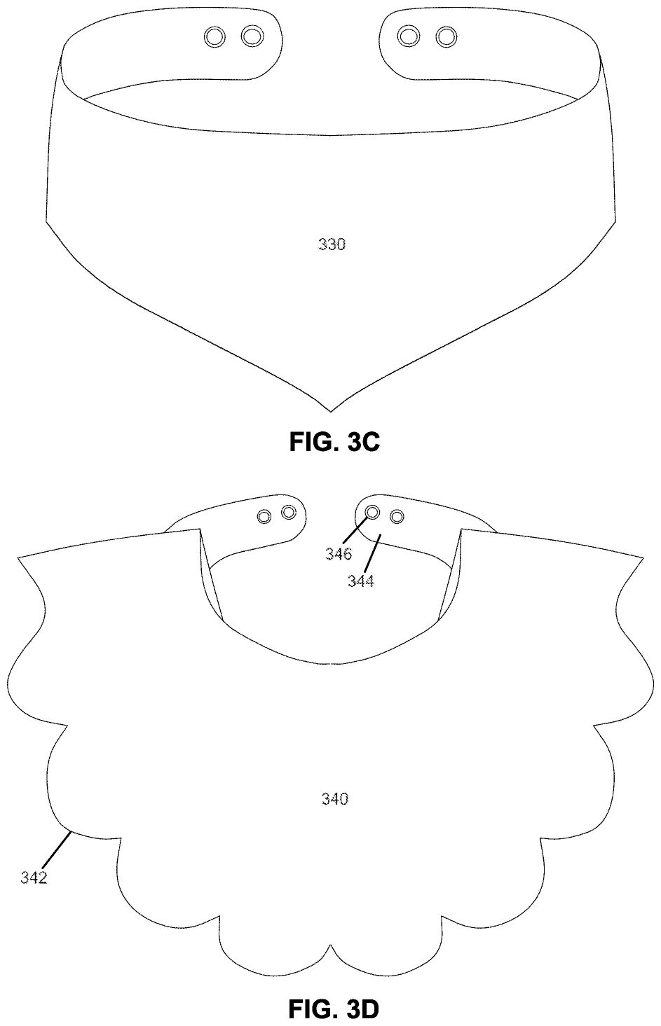

FIGS. 3A, 3B, 3C, and 3D showcase various example constructions of a bib utilizing the layer structure of the present invention, each designed to cater to different preferences and usage scenarios.

FIG. 3A illustrates a bib 310 that is configured to rest at the wearer's front, providing substantial coverage for clothing during meals or other activities. This bib features a string tie 312 that loops around the neck, allowing for easy adjustment to fit different neck sizes comfortably. The string tie design offers a traditional and straightforward method for securing the bib, ensuring it stays in place while being easy to put on and take off.

In FIG. 3B, the bib 320 is shown with a pair of wings 322 that are designed to wrap around the wearer's neck. This design includes a fastening mechanism 324 located at the ends of the wings, allowing them to be detachably coupled to one another. This fastening mechanism could include options such as snaps, Velcro, or buttons, providing a secure fit that can easily be adjusted to accommodate various neck sizes and ensure the bib remains aligned and protective.

FIG. 3C depicts a bib 330 with a body having a smaller surface area compared to the previous examples. This design wraps snugly around the wearer's neck and covers only a small portion of their front, making it less cumbersome and ideal for light use, such as drinking beverages. The smaller size makes it particularly suitable for quick tasks or for users who prefer minimalistic protective gear that doesn't cover much of their clothing.

Finally, FIG. 3D illustrates a bib 340 that offers extensive coverage with a larger surface area and a decorative frilled edge 342, enhancing the aesthetic appeal of the bib. This model also features wings 344 similar to those in FIG. 3B, equipped with fastening mechanisms 346, which allow the wings to be securely and detachably coupled. The larger size and frilled design make it suitable for situations requiring more substantial protection and a stylish appearance, such as during special occasion meals.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the multilayer structure and protective article of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A layered article comprising:
At least one outer fabric layer;
at least one absorbent inner layer disposed underneath the outer fabric layer; and
at least one waterproof inner membrane layer disposed underneath the at least one absorbent inner layer.

2. The layered article of claim 1, wherein the at least one outer fabric layer comprises a material selected from the group consisting of polyester, cotton, bamboo fabric, linen, hemp, silk, rayon, modal, lyocell, microfiber, and combinations thereof.

3. The layered article of claim 1, wherein the at least one absorbent inner layer comprises a material selected from the group consisting of terrycloth, fleece, and a bamboo-cotton blend.

4. The layered article of claim 3, wherein the material is terrycloth comprising substantially 80% bamboo and 20% cotton.

5. The layered article of claim 1, wherein the at least one waterproof inner membrane layer comprises a material selected from the group consisting of thermoplastic polyurethane (TPU) material, polyurethane laminate (PUL), vinyl, silicone, ethylene vinyl acetate (EVA), and combinations thereof.

6. The layered article of claim 1, further comprising a second absorbent inner layer disposed on the opposing side of the waterproof inner layer and a second outer fabric layer covering the second absorbent layer to form an article that is double-sided and reversible.

7. The layered article of claim 1, further comprising a one or more fasteners for securing the layered article around an object, wherein the fasteners are selected from the group consisting of snaps, ties, Velcro, and combinations thereof.

8. The layered article of claim 1, wherein the layered article is a protective garment selected from the group consisting of bibs and burp cloths.

9. The layered article of claim 1, wherein the layered article is a protective bedding article selected from the group consisting of bedding sheets and mattress covers.

10. The layered article of claim 1, wherein each of the absorbent inner layers and the waterproof inner layer is composed of at least two layers to enhance fluid absorption and prevention capabilities.

11. The layered article of claim 1, wherein the article is dimensioned and configured for use by individuals selected from the group consisting of babies, children, adults, and individuals with special needs.

12. The layered article of claim 1, wherein the article further includes a logo tag strategically placed to avoid interference with the absorbent and waterproof functionality while providing brand visibility.

13. The layered article of claim 1, wherein the article is treated with an antimicrobial agent to reduce the proliferation of bacteria and other microorganisms, thereby enhancing the hygienic properties of the article.
